(19) United States
(12) Patent Application Publication
(10) Pub. No.: US 2004/0074095 A1
(43) Pub. Date: Apr. 22, 2004

(54) Electromagnetic pulse welding of vehicle engine and exhaust components

(76) Inventors: Vincent M. Stempien, West Bloomfield, MI (US); Michael J. Blackie, New Hudson, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/620,175

(22) Filed: Jul. 15, 2003

Related U.S. Application Data
(60) Provisional application No. 60/396,155, filed on Jul. 15, 2002.

(51) Int. Cl. B23P 17/00

(52) U.S. Cl. 29/890.08

(57) ABSTRACT

A method and apparatus related to vehicular engine and exhaust components relies upon electromagnetic pulse welding techniques to attach and assemble a component that is free from weld spatter, such that the component may be used in a vehicle engine or exhaust system at a point upstream from the system's catalytic brick (including, but not limited to, components for turbo chargers, exhaust tubes and other such elements). The apparatus includes a first member, and an optional second tube, electromagnetically pulse welded to a second member. The members may be tubes or stamped metal pre-forms. Additionally or alternatively, one of the members may be a flange, another tubular assembly or a connector having single-ply, multi-layered or wire-braided construction. The method essentially involves providing and positioning the pieces to create a flow path and then electromagnetically pulse welding the pieces together in such a way as to avoid formation of weld spatter. The method also contemplates the use of a plastic or non-conductive guide member to aid in the protection, positioning and/or appropriate spacing of the workpieces being electromagnetically pulse welded. Reliance upon electromagnetic pulse welding produces components with superior results and performance in comparison to the prior art.

This invention relates to the fabrication of vehicle engine and exhaust components and in particular, to the electromagnetic pulse welding fabrication of components positioned upstream of the catalytic converter. This application is related to, and claims all statutory benefits of, the Provisional Patent Application Serial No. 60/396,155 entitled “ELECTROMAGNETIC PULSE WELDING OF VEHICLE ENGINE AND VEHICLE EXHAUST COMPONENTS” and filed on Jul. 15, 2002.

### FIELD OF INVENTION

### BACKGROUND OF INVENTION

Many vehicle and exhaust components are configured to fit within the confined spatial limitations of modern engine assemblies. Further, many vehicle and exhaust components are fabricated from materials that provide strength to withstand the operating and environmental conditions of driving while being light weight for fuel economy purposes.

In order to satisfy the above requirements, numerous vehicle engine and exhaust components are assembled or partially assembled by welding. For example, exhaust manifolds, which direct exhaust gases from the outlet ports of the engine combustion chamber to the exhaust system for discharge into the atmosphere, can be manufactured from two stamped halves and welded together.

The prior art has attempted to minimize the weld seams in vehicle engine and exhaust components for numerous reasons. For example, it has been observed that stress fractures in vehicle engine and exhaust components often begin or occur in the weld seam. Because many design concepts require welds in high temperature and stress areas, the chances of damaging the part during the welding process are increased. Furthermore, vehicle engine and exhaust components expand and contract in response to variable heat conditions, also increasing the likelihood that the weld seam may experience fatigue or cracking at some point during that component's lifespan.

An even more significant reason why the prior art has also attempted to minimize weld seams in vehicle engine and exhaust components is because many of these components are susceptible to damage from weld spatter that can dislodge from within the component. Weld spatter is not permitted in numerous vehicle engine components because of the potential for damage therefrom, especially those components which are in an upstream position from the catalytic converter. For example, turbo tubes are not permitted to have weld spatter because weld spatter may dislodge from within the turbo tubes and destroy the turbo charger if ingested, or the manifold could be damaged insofar as the EGR valve can become plugged with spatter. In short, other parts upstream of the catalytic converter (including but not limited to the manifolds required to channel exhaust fumes into the converter) cannot possess weld spatter because this spatter could become dislodged during vehicle operation and cause damage to the catalyst brick located downstream.

Therefore, there is a need in the art to fabricate vehicle engine and exhaust components with no weld spatter so as to prevent damage to the vehicle engine and exhaust system due to dislodged weld spatter. There is further a need in the art to fabricate vehicle engine and exhaust components having little to no weld seams in order to reduce the fracture potential associated with such seams.

In order to reduce vehicular weight, improve fuel economy, and further compact automotive parts, engine and exhaust components have been formed from lighter materials such thin walled stainless steel or INCO alloys. While these materials are acceptable because of their strength and lighter weight, problems can be experienced using conventional welding techniques with such components insofar as welding can also cause heat distortion in the component being fabricated. Therefore, there is a need in the art to prevent heat distortion during the fabrication of a vehicle engine or exhaust component.

Because of the heat distortion and weld spatter created by conventional welding techniques, fabricated vehicle engine and exhaust components tend to appear dirty or may even be discolored. While such discoloration generally does not affect the performance of the component per se, it creates an impression in the minds of many consumers that the quality of the part is in doubt. Therefore, there is a need in the art to provide vehicle engine and exhaust components that do not appear as dirty or discolored because of their fabrication technique.

Conventional welding techniques also create safety hazards to the welders themselves that are improved or eliminated completely utilizing the present invention. For example, in conventional MIG welding, exposure to the extreme heat and the sparks associated with conventional techniques gives rise to safety concerns for the welder and those in the immediate vicinity. Further, because the parts become red hot during welding, hand burns are very common amongst welders and others who may handle the recently welded parts. Therefore, there is a need in the art to provide a fabrication technique that improves or eliminates many of the safety concerns associated with conventional MIG welding.

Finally, welding can be an expensive process. Because of the extreme heat requirements for a proper conventional weld, the equipment necessary to generate proper welds, along with the skilled labor needed to operate this equipment, result in high costs. Therefore, there is a need in the art to provide vehicle and exhaust components that are created by less expensive means than the conventional, welding technique and that can be performed by operators who require less intensive training to perform such techniques.

Given the above, numerous attempts have been made to utilize safer, cleaner and more efficient welding techniques. For the reasons discussed in greater detail below, only limited attention has been given toward the use of electromagnetic pulse welding (EPW) techniques to construct vehicle components in recent years, although the general EPW technique itself has been known for several decades.

For example, U.S. Pat. No. 5,981,921 discloses a driveshaft tube manufactured using magnetic pulse welding techniques. U.S. Pat. No. 6,510,920 discloses an apparatus and method for manufacturing, through the use of a series of magnetic pulse welds, an exhaust tube contained within a larger, hydro-formed muffler or catalytic material holding chamber.

### SUMMARY OF INVENTION

The present invention contemplates a vehicle engine or exhaust component, positioned at a point upstream from that system's catalytic element, comprising a first element attached to a secondary element by an electromagnetic pulse weld which does not produce any weld spatter, and the attached pieces form a fluid flow path which, because of the absence of weld spatter, cannot damage the downstream elements (e.g., the turbo charger, EGR valve and/or the catalytic brick) by way of spatter becoming dislodged and carried downstream by the fluid. A connector element can also be included, and electromagnetically pulse welded, into the component. Other variations include the addition of flanges, the use of a multi-layered connector and/or the inclusion of one or more tubes to form multiple flow paths for fluids being transported through the component.

The invention also encompasses a method for manufacturing a component for vehicle engine or exhaust system that will be implemented in that system at a point that is upstream from the catalytic element of the system. The method includes providing two elements, positioned so that one is at least partially overlapping (or surrounded by, in the instance where the elements are tubular) the other in such a manner as to create a flow path for fluids being transported through the component and electromagnetically pulse welding the elements so as to create a component that is essentially devoid of any weld spatter. The completed component is then inserted into an engine or exhaust system at a point upstream from the catalytic element. Additional steps include providing a tube along with a branch opening in one of the elements, positioning the tube inside (or around the exterior of) the branch opening so as to create a secondary flow path for fluids being transported through the component that is not parallel to the original flow path created by the two elements and electromagnetically pulse welding the tube to the elements in order to form a component. Inclusion of at least one non-conductive cover, placed proximate to at least one of the elements, a tube and/or the branch opening in order to further assist in the welding process, is also possible.

### BRIEF DESCRIPTION OF THE SEVERAL VIEWS OF THE DRAWING

FIG. 1 is a perspective view of a turbo tube assembly according to the present invention.

FIG. 2 is an elevational view of the turbo tube assembly of FIG. 1.

FIG. 3 is an elevational view of a separate turbo tube assembly according to the present invention.

FIG. 4 is a perspective view of a manifold according to the present invention.

### DETAILED DESCRIPTION OF THE INVENTION

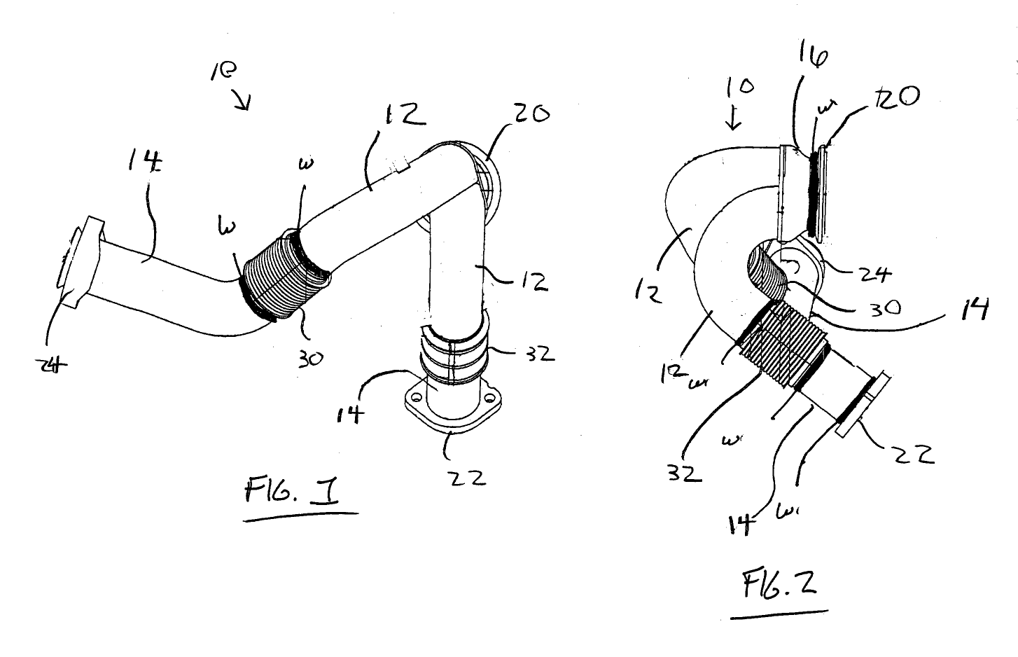

Reference is now made to the drawings. FIGS. 1 through 4 show vehicle engine and exhaust components having welds using the present invention. Although turbo tubes and an exhaust manifold are shown in the drawings for clarity of the disclosure, it is obvious that similar vehicular components wherein weld spatter must be minimized or eliminated can be welded using the present invention, and the term “vehicle exhaust component,” as used throughout the remainder of this specification, is intended to encompass any such component. Likewise, as used throughout this application and the claims appended hereto, reference to a position upstream of the catalytic converter, catalytic element or catalytic brick is generically intended to refer to any and all positions upstream of that element, including those positions that may be in direct fluid communication with the turbo charger, engine block and/or the intake portions of the exhaust system. Finally, to the extent that the present invention contemplates the use of non-tubular pre-forms welded together to form fluid transporting components, the invention encompasses a unique component construction in comparison to the aforementioned components which needed to be manufactured from tubular starting elements.

In use today, with limited success, is a recent innovation known as electromagnetic pulse welding. This technology employs a very high electromagnetic-induced force to swage two pieces of metal together. Although magnetic-pulse theory has been around for decades, electromagnetic pulse welding has not been utilized to a great degree due to the requirement of a high pulse current and strong magnetic fields. However, applying the techniques and benefits of electromagnetic pulse welding to the fabrication of complex vehicle engine and exhaust components, and especially those located upstream of the catalytic converter, not only appears to be novel but also addresses many of the industry concerns regarding conventional welding techniques mentioned above. Moreover, the fact that the industry has not previously or readily adopted the widespread use of EPW serves as proof of the difficulties associated with its implementation.

Electromagnetic pulse welding utilizes high velocity collision along with subsequent plastic deformation of two work pieces, placed either in parallel or at a small, relative angle. Electromagnetic pulse welding is accompanied by a localized temperature rise at the contact surfaces as a result of collision and ohmic eddy current effects: Melting and/or mechanical mixing and intense plastic deformation can cause formation of a transition zone of the weld. Tests clearly show that electromagnetic pulse welds are stronger than the weaker base materials. The stronger welds and high hardness of the transition zone is most likely caused by severe plastic deformation induced by collision or to fine-grain microstructure produced by melting and rapid solidification of the weld surface.

Electromagnetic pulse welding relies upon the interaction of magnetic fields, produced by an inductor through which an impulse of high intensity current is passed. In practice, magnetic-pulse welding normally utilizes two cylindrical materials fitted together where one material is sleeved over the other, although the present invention also contemplates using stamped metal pre-forms which, when fitted together, form a tubular structure (in this instance, the edges of the pre-forms are overlapping). Surrounding the outer sleeve/pre-form or positioned within the inner sleeve/pre-form is an inductor coil having an electrical current passing therethrough, and the magnetic forces that are created will accelerate the outer material toward the inner, welding them together (or vice versa in the case of the inductor being located within the inner sleeve).

The electromagnetic welding process, originally explored in the 1950's, relies on a magnetic field generated by discharging a capacitor bank into a specially designed coil. The intense magnetic field in turn creates extremely high eddy currents in the component next to the coil. These eddy currents create an intense magnetic field of opposite polarity to that in the coil. The result of these opposing magnetic fields is acceleration of the outer part into the other component. The resulting impact force is sufficient to produce strain levels (localized deformation) that result in the formation of a solid-state bond. Unique to magnetic pulse welding is the fact that this bond takes place at a considerably lower temperature than traditional welding processes with morphology similar to explosion welding.

Numerous benefits have been identified in the use of electromagnetic pulse welding. Electromagnetic pulse welding requires a relatively low heat input requirement. It has been noted that a typical magnetic-pulse weld requires approximately 100 times less energy than an equivalent MIG weld (Gas Metal Arc Welding), in part because the heating which occurs is localized to the weld area only. Therefore, electromagnetic pulse welding appears to provide a cost savings over conventional welding techniques. Furthermore, because the excessive heat required for conventional welding process also causes heat distortion and deformation of the areas of the work piece proximate to (but not actually part of) the weld area, EPW techniques also minimize issues associated with heat distortion and deformation, and discoloration of the components is eliminated for the same reason. Most importantly, the welds created by EPW do not require the use of a filler material or otherwise create unwanted weld spatter, thereby providing an attractive alternative to conventional techniques wherein intensive effort was required after the welding process to remove such spatter, both for aesthetic and operational reasons (discussed above).

The result is that magnetic-pulse welding produces extremely straight and even welds of high quality and strength, even utilizing dissimilar metals such as steel to other alloys. Further, electromagnetic pulse welding discharges its current to produce a weld in less than one second, thereby producing a quick weld, although the cycle time of the welding apparatus is dependent upon the fixturing of the work piece and the recharge time.

Also, such a process for welding requires a lower operator skill level than required in conventional welding because the process can be easily automated. Further, electromagnetic welding reduces many of the environmental concerns associated with previous techniques, such as weld run-off, extreme heat and exposure to flammable gases or toxic fumes.

Electromagnetic pulse welding uses massive magnetic fields to force metal pieces together at supersonic speed, solidly bonding them. The bond is achieved at the molecular level at a much lower temperature than conventional MIG welding. The process requires the outer material to be conductive, otherwise the magnetic force won't affect it. This property can be usefully manipulated insofar as it is possible to weld through plastic or other non-conductive materials, so long as the plastic/non-conductive material is sufficiently proximate to the work pieces being welded. For example, a metallic part can be welded to another part while still enclosed in or retained by a plastic cover.

Another necessity for successful EPW is that the current must be delivered to the coil in a symmetrical fashion to create an even distribution of magnetic energy. If the magnetic force is not distributed symmetrically, unintended deformation occurs, usually jeopardizing the weld and ruining the part. Consequently, proper construction of a uniform coil, along with precise positioning of the coil and the work pieces, is essential. As above, the inventors have discovered that reliance upon non-conductive parts to protect sensitive parts and/or to assist in the positioning parts can be extremely beneficial to the process.

Numerous components and configurations can be constructed utilizing electromagnetic pulse welding as opposed to conventional welding. Although many components can be welded using the present invention, FIGS. 1 through 4 show three specific vehicle exhaust components that are particularly well-suited to fabrication according to the present invention. The standard connections, currently made by conventional welding techniques, can now be performed using electromagnetic pulse welding techniques. Further, FIGS. 1 through 4 depict parts that could be made using conventional MIG welding techniques, but with the numerous difficulties and disadvantages described above (i.e., concerns about/removal of weld splatter, discoloration, operator training, non-uniformity of welds, etc.). Through the use of the present invention, all of these parts can now be manufactured using the electromagnetic pulse welding process to form superior vehicle engine and exhaust components.

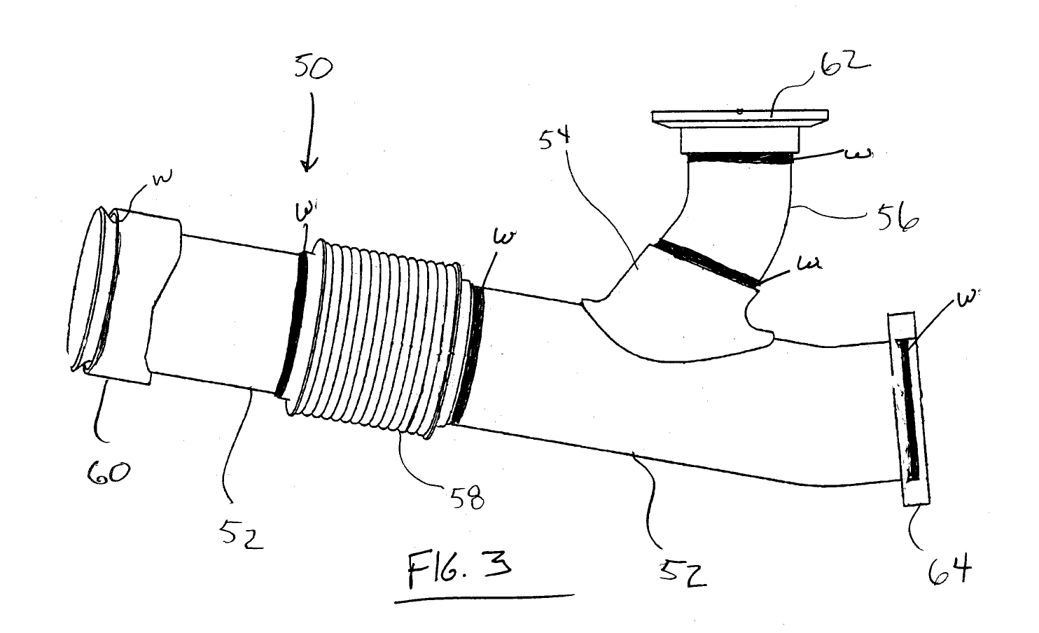

Turning particularly to FIGS. 1 and 2, a first embodiment of the invention is shown. Essentially, component 10 includes tubular assemblies 12 and 14 connected to a connecting piece 16. Flanges 20, 22 and 24 may be provided, along with connecting elements 30, 32. The points at which electromagnetic pulse welds are most preferably utilized are indicated by reference element W. Notably, the alignment and positioning of the aforementioned elements is such that the tubular assemblies form a curved and tortuous flow path for exhaust fumes. As will be readily appreciated by those skilled in the art, the particular complex configuration of parts and/or the tortuous flow path for exhaust fumes created thereby will be dictated by spatial limitations and design concerns of the system into which the component 10 will be incorporated. Equally important, the interior passageways formed by these parts will be free from any harmful weld spatter, thereby permitting use of the component 10 in a position upstream of the catalytic element or in fluid connection with the engine block and without the need for costly deburring or other spatter removal processes.

The connecting elements 30, 32 typically have a larger diameter than the tubular assemblies 12, 14 in which they are incorporated. These parts can themselves act as connecting pieces to which portions of tubes can be electromagnetically pulse welded, preferably at locations W. More importantly, the connecting elements 30, 32 may be constructed of a single ply or multiple layers of material or a wire braid, although those skilled in the art will readily recognize the significance and applicability of such constructions. In either case, a preferred embodiment of the invention contemplates using a single electromagnetic pulse welding step to join the connecting elements 30, 32 to their respective tubular assemblies 12, 14.

Notably, tubular assemblies 12, 14 are positioned on the same facing of the connector 16. The connector itself can form a secondary flow path for exhaust fumes. To the extent exhaust fumes may be merged or directed into separate flow paths, it should be noted that the complex arrangement contemplated by this invention requires these flow paths to diverge, to meet at acute and/or obtuse angles, to flow in differing spatial planes or to otherwise be configured such that the flow paths are not parallel.

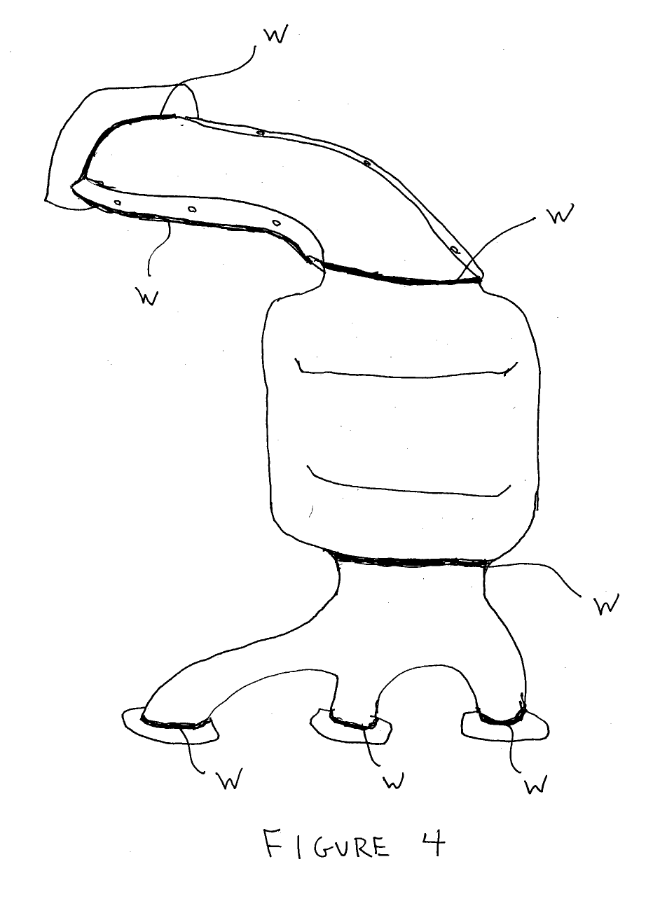

FIG. 3 illustrates another embodiment of the invention. Here, turbo tube component 50 comprises first tubular member 52, branch opening 54 and separate tubular member 56. As before, optional connecting element 58 may be included, along with flanges 60, 62, 64, and locations W indicate ideal areas for electromagnetic pulse welds. Significantly, the construction of component 50 is such that exhaust fumes flowing therethrough are split into separate flow paths. Again, these flow paths are essentially non-linear and, in comparison to one another, nonparallel.

FIG. 4 depicts yet another embodiment of the invention. Here, the connecting element joins two stamped members, fitted together to form an enclosed passageway. A separate tubular member, attached at a position upstream from the catalytic element, or plurality of EPW pre-forms, also possess a plurality of flow passages which are merged into a single passageway. In turn, this single tube is electromagnetically pulse welded to the connector, which may contain a catalytic brick or similar material. As above, location W depicts ideal areas for all of the various EPW processes that may be incorporated. Pre-form pieces, joined by an EPW process, may also be fabricated for inclusion downstream from the connector.

In each of the aforementioned devices, the method by which the device is assembled should be intuitive. The various elements must be provided and positioned to create the flow path(s) contemplated above. The precise configuration and positioning of the inductor coil is inherent to the electromagnetic pulse welding process, although it should be noted that the coil may be positioned inside of and/or around the pieces being welded. Ultimately, the positioning and shape of the coil will be dictated by the particular part being welded.

Because EPW processes do not affect plastic or non-conductive articles, it may be possible to use a plastic or non-conductive sleeve to afford further protection against scratches, to assist in positioning the elements and/or to otherwise separate the workpieces being welded from certain environments. Ultimately, the shape, construction and use of non-conductive members will be dictated by the requirements of the particular component being manufactured.

In all of the instances described above, the interior passageways formed by the resulting component are free from weld spatter or other deformities which could become dislodged from the part and be carried downstream through the flow paths, thereby damaging the engine, turbo charger, EGR valve or catalytic brick. Similarly, the exterior of such components is essentially free from discoloration, weld spatter and/or other deformities that may cause a consumer to question the quality of the component. Consequently, components manufactured according to the present invention are suitable for use in positions both upstream, as well as downstream, from the relatively fragile catalytic brick found in the catalytic converter or EGR valve or turbo charger the vehicle.

The invention has been described with reference to embodiments described above. Nevertheless, modifications and alternations will occur to others upon a reading and understanding of this specification. The following claims are intended to include any and all such modifications and alterations insofar as the scope of the claims encompass these modifications and alterations, along with any equivalents thereof.

We claim:

1. A component for transporting fluids from a vehicle engine through a vehicle exhaust system, said vehicle exhaust system having a catalytic element, the component comprising:
a first metallic member; and
a second metallic member attached without formation of weld spatter to the first member by an electromagnetic pulse weld, said weld positioned at a point upstream from the catalytic element, and said second member and the first member defining a flow path for fluids being transported therethrough.

2. The component according to claim 1 wherein the first member comprises a first tubular member and second member comprises a second tubular member, and the component further comprising:
a connector element attached without the formation of weld spatter by an electromagnetic weld to at least one selected from the group consisting of: the first tubular member and the second tubular member, said weld(s) positioned at a point upstream from the catalytic element.

3. The component according to claim 2 wherein the connector element, the first tubular member and the second tubular member define a curved or tortuous flow path for the fluid being transported therethrough.

4. The component according to claim 3 further comprising at least one flange attached without formation of weld spatter by an electromagnetic pulse weld to at least one item selected from the group consisting of: a terminal end of the first tubular member, a terminal end of the second tubular member and the connector element, said weld(s) positioned at a point upstream from the catalytic element.

5. The component according to claim 1 wherein the first member comprises a first tubular member and the second member comprises a second tubular member, and the component further comprising:
a secondary tubular assembly, optionally including a secondary connector element attached without formation of weld spatter by an electromagnetic pulse weld to said secondary tubular assembly, said weld positioned at a point upstream from the catalytic element; and
a connector element attached to a terminal end of the first tubular member and also attached to a terminal end of the secondary tubular assembly, said connector element and the secondary tubular assembly defining a secondary flow path for fluids transported therethrough that is not parallel to the flow path defined by the first tubular member and the second tubular member.

6. The component according to claim 5 further comprising at least one flange attached without formation of weld spatter by an electromagnetic pulse weld to at least one item selected from the group consisting of: a terminal end of the second tubular member, a terminal end of the connector element and the optional secondary connecting element, said weld(s) positioned at a point upstream from the catalytic element.

7. The component according to claim 1 wherein the first member comprises a first tubular member and the second member comprises a second tubular member, said second tubular member attached without the formation of weld spatter to a branch opening in the first tubular member by an electromagnetic pulse weld, said weld positioned at a point upstream from the catalytic element, and wherein the first tubular member also individually defines a secondary flow path for fluids transported through the component that is not parallel to the flow path defined by the first tubular member and the second tubular member.

8. The component according to claim 7 further comprising at least one flange attached without formation of weld spatter by an electromagnetic pulse weld to at least one item selected from the group consisting of: a first end of the first tubular member; an opposite end of the first tubular member and a terminal end of the second tubular member, said weld(s) positioned at a point upstream from the catalytic element.

9. The vehicle exhaust component according to claim 1 wherein the first member comprises a first tubular member and the second member comprises a second tubular member and wherein at least two discrete flow channels are provided for fluids transported through a first end of the first tubular member, said discrete flow channels merging within the first tubular member such that an opposite end of the first tubular member constitutes a single flow channel, said the opposite end of the first tubular member attached without the formation of weld spatter by an electromagnetic pulse weld to the secondary element, said weld positioned at a point upstream from the catalytic element.

10. The vehicle exhaust component according to claim 9 further comprising at least one flange attached without formation of weld spatter by an electromagnetic pulse weld to at least one item selected from the group consisting of: a terminal end of at least one of the flow channels of the first tubular member and the second tubular member, said weld(s) positioned at a point upstream from the catalytic element.

11 The vehicle exhaust component according to claim 2 wherein the connector element includes at least two concentrically arranged layers, said layers attached without the formation of weld spatter by a single electromagnetic pulse weld process.

12. The vehicle exhaust component according to claim 11 further comprising at least one flange attached without formation of weld spatter by an electromagnetic pulse weld to at least one item selected from the group consisting of: a terminal end of the first tubular member, a terminal end of the second tubular member and the connector element, said weld(s) positioned at a point upstream from the catalytic element.

13 The vehicle exhaust component according to claim 2 wherein the connector element includes a wire braid, said wire braid attached without the formation of weld spatter by a single electromagnetic pulse weld process.

14. The vehicle exhaust component according to claim 13 further comprising at least one flange attached without formation of weld spatter by an electromagnetic pulse weld to at least one item selected from the group consisting of: a terminal end of the first tubular member, a terminal end of the second tubular member and the connector element, said weld(s) positioned at a point upstream from the catalytic element.

15. A method for manufacturing a component for transporting fluids from a vehicle engine through a vehicle exhaust system, said vehicle exhaust system having a catalytic element, the method comprising:
providing a first member and a second member;
positioning the second member over a portion of the first member so as to define a flow path for fluids transported therethrough; and
using an electromagnetic pulse welding process to attach the first member and second member without formation of weld spatter so as to create a welded component, said weld positioned upstream of the catalytic element.

16. The method of claim 15, further comprising:
providing a tubular member;
providing a branch opening in the first member;
positioning the third tubular member within or over the branch opening so as to define a secondary flow path for fluids transported through the component that is not parallel to the flow path defined by first member and the second member; and
using an electromagnetic pulse welding process to attach the third tubular member and the branch opening without the formation of weld spatter so as to create the component.

17. The method of claim 16 further comprising:
providing at least one non-conductive cover; and
positioning the cover proximate to at least one selected from the group consisting of: the first member, the second member, the tubular member and the branch opening, such that the cover assists in the creation of the component.

18. The method of claim 15 further comprising:
providing at least one non-conductive cover; and
positioning the cover proximate to at least one selected from the group consisting of: the first member and the second member, such that the cover assists in the creation of the component.

19. A component for transporting fluids associated with a vehicle engine or exhaust system, the component comprising:
a first non-tubular member; and
a second non-tubular member attached by an electromagnetic weld to the first tubular member so as to define a flow path for fluids being transported therethrough that is essentially free from weld spatter.

20. A component according to claim 19 wherein the first non-tubular member and the second non-tubular member form at least two discrete flow channels at a first end of the component, said discrete flow channels merging within the component such that an opposite end of the component constitutes a single flow channel.
